(19) United States
(12) Patent Application Publication
(10) Pub. No.: US 2007/0250611 A1
(43) Pub. Date: Oct. 25, 2007

(54) Method of and System for Providing Performance Information in a UDDI System

(76) Inventors: Kulvir Singh Bhogal, Fort Worth, TX (US); Gregory Jensen Boss, American Fork, UT (US); Rick Allen Hamilton II, Charlottesville, VA (US); Alexandre Polozoff, Bloomington, IL (US)

Correspondence Address: Jonathan E. Jobe, P.C., 11625 Sawtooth Court, Truckee, CA, 96161, US

(21) Appl. No.: 11/379,386

(22) Filed: Apr. 20, 2006

(51) Int. Cl. G06F 15/173

(52) U.S. Cl. 709/223

(57) ABSTRACT

A method of and system for providing performance information in a Universal Description, Discovery and Integration (UDDI) system periodically requests data from Web service providers that are registered in a UDDI registry. The method and system determine performance attributes for the Web service providers based upon the requested data. The method stores the latest, or most current, performance attributes in a performance metric store that is accessible by the UDDI registry. The UDDI registry services requests from Web service consumers for performance attributes of service providers that provide specified Web services. The UDDI registry accesses the performance metric store to obtain current performance attributes for the Web service providers and returns the performance attributes to the Web service consumer. The Web service consumer can use the performance attributes to select a Web service.

### FIELD OF THE INVENTION

The present invention relates generally to the field of Universal Description, Discovery and Integration (UDDI) systems, and more particularly to a UDDI system that includes a performance monitoring system that makes available to a UDDI registry performance attributes for Web services registered with the UDDI registry.

### BACKGROUND OF THE INVENTION

Universal Description, Discovery and Integration (UDDI) is a standards-based set of services supporting the description and discovery of Web service providers, the services the Web service providers make available, and the technical interfaces that may be used to access the services. Web services typically include data and/or small applications that may be used by Web service consumers or integrated into Web service consumers' solutions. Examples of Web services include stock quotes, local weather, Body Mass Index (BMI) calculators, and the like. Using common industry standards, such as HTTP, XML and SOAP, UDDI provides an interoperable infrastructure for a Web services-based software environment for both public available services and services exposed only internally within an organization.

A key component of the UDDI system is a UDDI registry. A UDDI registry allows Web service providers to register information about the Web services they offer so that Web service consumers can find them and use their services. A UDDI registry stores Web Service Definition Language (WSDL) files. WSDL is an XML-based language that describes an interface of a Web service together with information on how to call the Web service and where to find it.

A Web service provider can register three types of information in a UDDI registry. These types of information are commonly referred to as White Pages, Yellow Pages, and Green Pages. The White Pages contain basic identification information such as name, address, or other identifiers, such as Dun & Bradstreet's D-U-N-S numbers. The White Pages allow consumers to find a Web service provider based upon its identity. The Yellow Pages describe Web services using different categories or taxonomies. The Yellow pages allow consumers to find Web service providers based upon the categories of services they provide. The Green Pages provide technical information about how to interface with the Web service provider's services.

UDDI allows a consumer to find a Web service using means such as database look-ups, configuration files, or by making a Web service call to an ad hoc broker service. UDDI supports a very flexible taxonomy-based query mechanism that allows a consumer to select Web service based on classification schemes, such as physical location, cost of use, Quality of Service (QOS) guarantees, and the like. Though the provider of a Web service may claim a QOS guarantee, there is no feedback mechanism in place by which a UDDI registry can receive input from a third party regarding the delivery of a Web service.

### SUMMARY OF THE INVENTION

In one of its aspects, the present invention provides a method of providing performance information in a Universal Description, Discovery and Integration (UDDI) system. A method according to the present invention requests data from a Web service provider that is registered in a UDDI registry. The method determines at least one performance attribute for the Web service provider based upon the requested data. Then, the method stores the at least one performance attribute in a performance metric store that is accessible by the UDDI registry.

Preferably, the method periodically requests data from a plurality of Web service providers, each of which is registered with the UDDI registry. The method stores the latest, or most currently determined, performance attribute for each of the Web service providers in the performance metric store. Thus, the method dynamically updates the performance attributes stored in the performance metric store.

The UDDI registry receives requests from Web service consumers for lists of Web service providers that provide specified Web services. According to a method of the present invention, the UDDI registry may access the performance metric store to obtain performance attributes for the listed Web service providers. The UDDI registry may return the performance attributes either along with the list or in response to a separate request from the Web service consumer.

The UDDI registry and performance monitoring processes of a method according to the present invention may run independently of each other. The performance monitoring process goes about its work of dynamically updating the contents of the performance metric store with currently determined performance attributes. At the same time, the UDDI registry services requests from Web service consumers with current performance attributes stored in the performance metric store.

### BRIEF DESCRIPTION OF THE DRAWINGS

FIG. 1 is a block diagram of a system according to the present invention.

FIG. 2 is a flow chart of an embodiment of performance monitor processing according to the present invention.

FIG. 3 is a message flow diagram according an embodiment of the present invention.

FIG. 4 is a message flow diagram according to an alternate embodiment of the present invention.

FIG. 5 is a block diagram of an information handling system adapted to implement components of a system according to the present invention.

### DETAILED DESCRIPTION

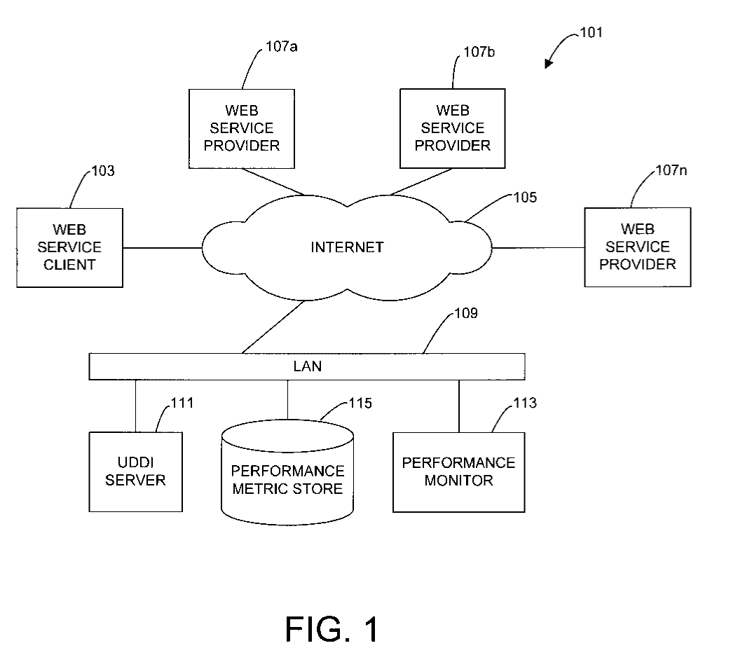

Referring now to the drawings, and first to FIG. 1, an embodiment of a system according to the present invention is designated generally by the numeral 101. System 101 is preferably implemented in a network environment. A Web service client computer 103 is connected to the Internet 105. A plurality of Web service provider computers, including Web service providers 107a, 107b, and 107n, are also connected to Internet 105. Web service client 103 and Web service providers 107a-n may thus communicate with each other using well known protocols. Although FIG. 1 illustrates a network comprising the Internet, it will be recognized that other networks, such as internal intranets, may be used according to the present invention.

As is known by those skilled in the art, Web service providers 107a-n are adapted to provide Web services. Web services typically include data and/or small applications that may be used by Web service consumers or integrated into Web service consumers' solutions. Examples of Web services include stock quotes, local weather, Body Mass Index (BMI) calculators, and the like.

When a Web service consumer integrates a Web service into its solution, the Web service consumer wants the Web service to provide accurate, reliable and timely information. It is therefore important to Web service consumers that Web services meet certain quality of service (QOS) standards. Additionally, a Web service consumer may want to use the Web service that provides the most accurate, reliable and timely information. Accordingly, the system of the present invention provides to Web service consumers performance information obtained by a trusted third-party provider.

A local area network (LAN) 109 is also connected to Internet 105. LAN 109 may be of any topology. A Universal Description, Discovery and Integration (UDDI) server computer 111 is connected to LAN 109. UDDI server 111 operates in a manner well known to those skilled in the art; however UDDI server 111 includes additional features according to the present invention that will be described in detail hereinafter. Also, connected to LAN 109 is a performance monitor computer 113, the operation of which will be described in detail hereinafter. Finally, a performance metric store 115 is connected to LAN 109. While UDDI server 111 and performance monitor 113 are illustrated as separate machines, it will be recognized that their functions may be implemented as separate processes running on a single machine.

UDDI server 111 and performance monitor 113 may communicate with each other and with performance metric store over LAN 109. UDDI server 111 and performance monitor 113 may also communicate with Web service client 103 and Web service providers 107a-n over Internet 105.

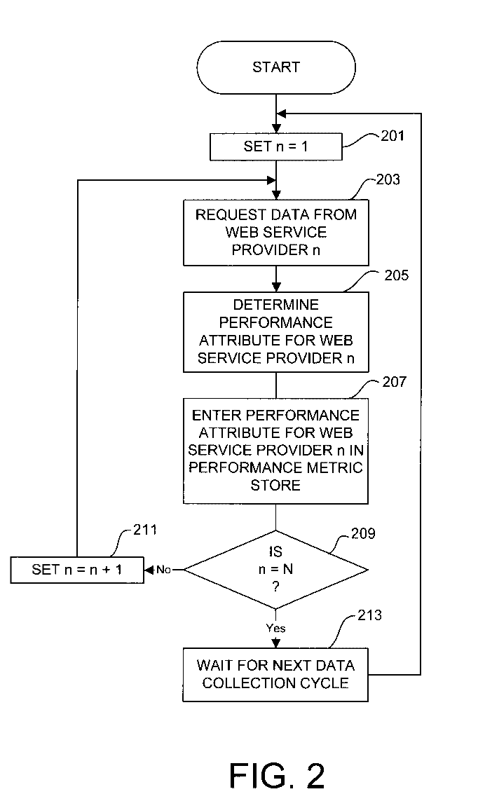

Briefly, performance monitor 113 is adapted to collect information from Web service providers and, from the collected information, determine performance attributes. Performance monitor 113 stores the performance attributes in the performance metric store 115 for use by UDDI server 111. Referring to FIG. 2, which comprises a flow chart of an implementation of performance monitor processing according to the present invention, performance monitor processing is initialized at block 201 by setting an index n equal to 1. Each Web service provider 107 is assigned an identifier n from 1 to N. The performance monitor requests data from service provider n, at block 203, according to the interface appropriate for service provider n. The performance monitor receives the data returned from Web service provider n and, at block 205, determines a performance attribute, or attributes, for Web service provider n. A performance attribute may simply be response time measured from the time of the request to the time of the receipt of the return. Other examples of performance attributes will be apparent to those skilled in the art. For example, a performance attribute may be mean response time over a particular period, maximum response time over the period, standard deviation of response times, or the like.

After the performance monitor has determined the performance attribute or attributes, the performance monitor enters the performance attribute or attributes determined for Web service provider n in the performance metric store, at block 207. Typically, the performance monitor overwrites any performance attribute previously stored in performance metric store for Web service provider n. Then, the performance monitor tests, at decision block 209, if n is equal to N. If not, the performance monitor sets n equal to n plus 1, at block 211, and processing returns to block 203. If, as determined at decision block 209, index n is equal to N, then the performance monitor waits for the next data collection cycle, at block 213. Data collection cycles may be performed on any time period desired by the system designer. After having waited for the next data collection cycle, performance monitor processing returns to block 201.

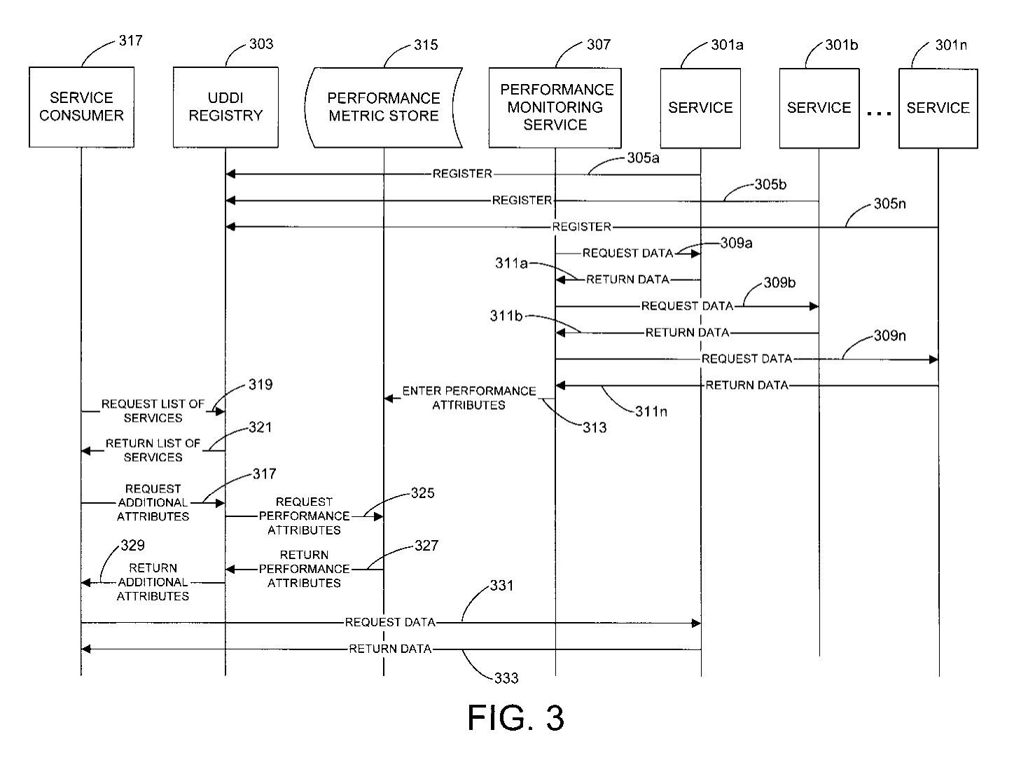

Referring now to FIG. 3, there is illustrated a message flow diagram according to one embodiment of a system according to the present invention. Services 301a, 301b and 301n each register with a UDDI registry 303 by sending register messages 305a, 305b and 305n, respectively. The registration of services may occur at any time and in any order. Performance monitoring service 307 requests data from each registered service 301a, 301b and 301n by sending data requests 309a, 309b and 309n, respectively. Services 301a, 301b and 301n respond to the data requests by returning data, as indicated at 311a, 311b and 311n, respectively. As described with respect to FIG. 2, performance monitoring service 307 determines performance attributes from the data returned from services 301a, 301b and 301n. Performance monitoring service 307 enters the performance attributes in performance metric store 315, as indicated at 313.

A service consumer 317 requests a list of services from UDDI registry 303, as indicated at 319, according to the UDDI standard. UDDI registry returns a list of services, as indicated at 321. Service consumer 317 may request additional attributes for the services listed in the return from UDDI registry 303, as indicated at 325. Additional attributes may include attributes registered by services 301a-n as well as performance attributes determined by performance monitoring service 307. UDDI registry 303 requests performance attributes from performance metric store 315, as indicated at 325. Performance metric store returns performance attributes, at 327, to UDDI registry 303. UDDI registry in turn returns additional attributes including the performance attributes to service consumer 317, as indicated at 329. Service consumer 317 uses the additional attributes, including the performance attributes, to determine which service 301a-n to use. After having selected a service, service consumer 317 requests data from selected service 301a, as indicated at 331. The service 301a services the request, as indicated at 333.

It should be recognized that the processes illustrated in FIG. 3 are performed at least partially independent of each other. For example, registration of services with UDDI registry, indicated at 305a-n, occurs essentially once, while performance monitoring service processing, indicated at 309a-313, and service consumer processing, indicated at 319-333, may occur more frequently, but independent of each other.

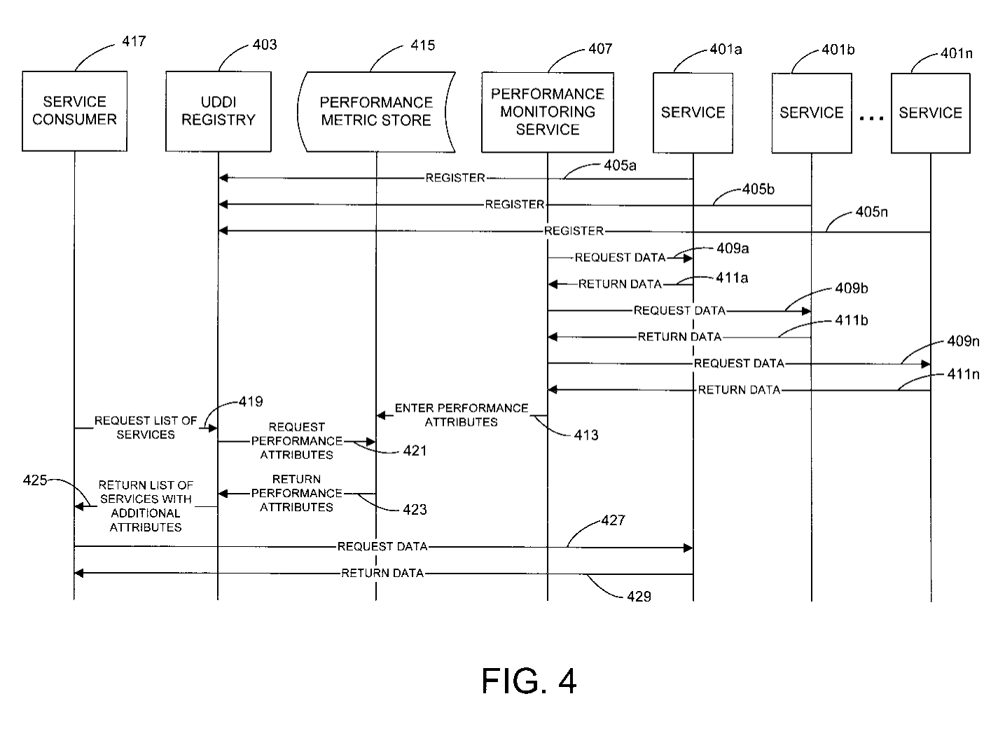

Referring now to FIG. 4, there is illustrated a message flow diagram according to a second embodiment of a system according to the present invention. Services 401a, 401b and 401n each register with a UDDI registry 403 by sending register messages 405a, 405b and 405n, respectively. The registration of services may occur at any time and in any order. Performance monitoring service 407 requests data from each registered service 401a, 401b and 401n by sending data requests 409a, 409b and 409n, respectively. Services 401a, 401b and 401n respond to the data requests by returning date, as indicated at 411a, 411b and 411n, respectively. As described with respect to FIG. 2, performance monitoring service 407 determines performance attributes from the data returned from services 401a, 401b and 401n. Performance monitoring service 407 enters the performance attributes in performance metric store 415, as indicated at 413.

A service consumer 417 requests a list of services from UDDI registry 403, as indicated at 419, according to the UDDI standard. Processing according to FIG. 4 differs from that of FIG. 3 in that UDDI registry 403, rather than simply returning a list of registered services satisfying request 419, requests performance attributes from performance metric store 415, as indicated at 421. Performance metric store 415 returns performance attributes, at 423, to UDDI registry 403. UDDI registry 403 then returns a list of services satisfying the query of service consumer 417 together with additional attributes including the performance attributes, as indicated at 425. Service consumer 417 then determines which service 401a-n to use. After having selected a service, service consumer 417 requests data from selected service 401a, as indicated at 427. The service 401 a services the request, as indicated at 429.

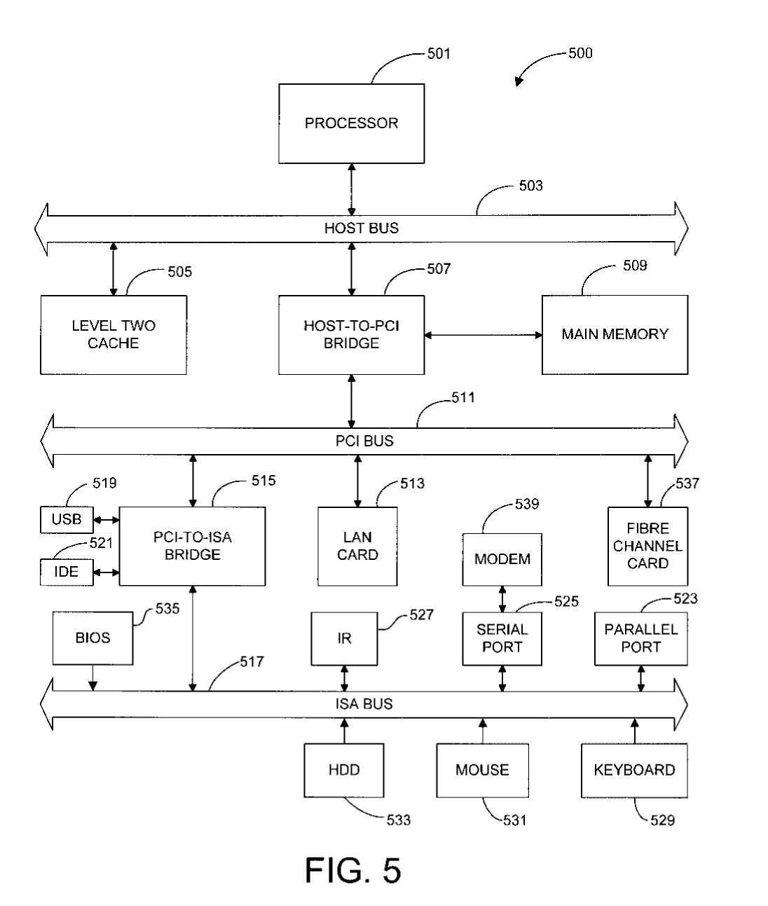

Referring now to FIG. 5, there is illustrated a block diagram of a generic information handling system 500 capable of performing the server and client operations described herein. Computer system 500 includes processor 501 which is coupled to host bus 503. Processor 501 preferably includes an onboard cache memory. A level two (L2) cache memory 505 is also coupled to host bus 503. A Host-to-PCI bridge 507 is coupled to host bus 503. Host-to-PCI bridge 507, which is coupled to main memory 509, includes its own cache memory and main memory control functions. Host-to-PCI bridge 507 provides bus control to handle transfers among a PCI bus 511, processor 501, L2 cache 505, main memory 509, and host bus 503. PCI bus 511 provides an interface for a variety of devices including, for example, a local area network (LAN) card 513, a PCI-to-ISA bridge 515, which provides bus control to handle transfers between PCI bus 511 and an ISA bus 517, a universal serial bus (USB) 519, and an IDE device 521. PCI-to-ISA bridge 515 also includes onboard power management functionality. PCI-to-ISA bridge 515 can include other functional elements not shown, such as a real-time clock (RTC), DMA control, interrupt support, and system management bus support.

Peripheral devices and input/output (I/O) devices can be attached to various interfaces or ports coupled to ISA bus 517. Such interfaces or ports may include a parallel port 523, a serial port 525, an infrared (IR) interface 527, a keyboard interface 529, a mouse interface 531, and a hard disk drive (HDD) 533.

A BIOS 535 is coupled to ISA bus 517. BIOS 535 incorporates the necessary processor executable code for a variety of low-level system functions and system boot functions. BIOS 535 can be stored in any computer readable medium, including magnetic storage media, optical storage media, flash memory, random access memory, read only memory, and communications media conveying signals encoding the instructions (e.g., signals from a network). In order to couple computer system 500 to another computer system to copy files or send and receive messages over a network, LAN card 513 may be coupled to PCI bus 511. Similarly, a Fibre Channel card may be coupled to PCI bus 513. Additionally, a modem 539 may be coupled to ISA bus 517 through serial port 525 to support dial-up connections.

While the computer system described in FIG. 5 is capable of executing the invention described herein, the illustrated system is simply one example of a computer system. Those skilled in the art will appreciate that many other computer system designs are capable of performing the invention described herein.

One of the preferred implementations of the invention is an application, namely, a set of instructions (program code) in a code module that may, for example, be in the random access memory of the computer. Until required by the computer, the set of instructions may be stored in another computer memory, for example, on a hard disk drive, or in removable storage such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

From the foregoing, it may be seen that processes and systems according to the present invention are well adapted to overcome the shortcomings of the prior art. The processes and systems of the present invention provide performance attributes from a trusted third-party that may be useful to a Web service consumer in selecting a Web service. While the present invention has been illustrated and described with reference to exemplary embodiments, those skilled in the art will recognize alternate embodiments. Accordingly, the foregoing description is intended for purposes of illustration rather than limitation.

What is claimed is:

1. A method of providing performance information in a Universal Description, Discovery and Integration (UDDI) system, which comprises:
requesting data from a Web service provider, said Web service provider being registered in a UDDI registry;
determining at least one performance attribute for said Web service provider based upon said requested data; and,
storing said at least one performance attribute in a performance metric store accessible by said UDDI registry.

2. The method as claimed in claim 1, including:
requesting data from a plurality of Web service providers, each of said Web service providers being registered in said UDDI registry;
determining at least one performance attribute for each of said Web service providers based upon said requested data; and,
storing said at least one performance attribute for each of said Web service providers in said performance metric store.

3. The method as claimed in claim 1, including:
periodically requesting data from said Web service provider; and,
updating said at least one performance attribute in said performance metric store based upon said periodically requested data.

4. The method as claimed in claim 1, including:
receiving a request from a Web service consumer at said UDDI registry;
in response to said request, accessing said performance metric store; and,
returning to said Web service consumer a performance attribute stored in said performance metric store.

5. The method as claimed in claim 2, including:
periodically requesting data from each of said Web service providers; and,
updating said at least one performance attribute in said performance metric store for each of said Web service providers based upon said periodically requested data.

6. The method as claimed in claim 5, including:
receiving a request from a Web service consumer at said UDDI registry;
in response to said request, accessing said performance metric store; and,
returning to said Web service consumer a performance attribute stored in said performance metric store for each of said Web service providers.

7. A Universal Description, Discovery and Integration (UDDI) system, which comprises:
a performance metric store; and,
a performance monitoring service coupled to said performance metric store.

8. The system as claimed in claim 7, wherein said performance monitoring service includes:
means for requesting data from a Web service provider;
means for determining at least one performance attribute for said Web service provider; and,
means for storing said at least one performance attribute in said performance metric store.

9. The system as claimed in claim 8, including a UDDI registry coupled to said performance metric store.

10. The system as claimed in claim 9, wherein said UDDI registry includes:
means for receiving requests from a Web service consumer;
means for accessing said performance metric store to retrieve said at least one performance attribute;
means for returning to said Web service consumer said performance attribute retrieved from said performance metric store.

11. The system as claimed in claim 7, wherein said performance monitoring service includes:
means for periodically requesting data from each of a plurality of Web service providers;
means for determining, for each of said Web service providers, a performance attribute based upon data returned from said Web service providers; and,
means for periodically updating in said performance metric store the performance parameters for each said Web service provider.

12. The system as claimed in claim 11, including a UDDI registry coupled to said performance metric store.

13. The system as claimed in claim 12, wherein said UDDI registry includes:
means for receiving a request from a Web service consumer;
means for accessing said performance metric store to retrieve an updated performance attribute for each said Web service provider;
means for returning to said Web service consumer said updated performance attributes retrieved from said performance metric store.

14. The system as claimed in claim 7, wherein said performance monitoring service includes:
means for periodically requesting data from each of a plurality of Web service providers;
means for determining, for each of said Web service providers, a performance attribute based upon data returned from said Web service providers; and,
means for periodically updating said performance metric store with most recently determined performance parameters for each said Web service provider.

15. The system as claimed in claim 14, including a UDDI registry coupled to said performance metric store.

16. The system as claimed in claim 15, wherein said UDDI registry includes:
means for receiving a request from a Web service consumer;
means for accessing said performance metric store to retrieve said most recently determined performance attribute for each said Web service provider;
means for returning to said Web service consumer at least one most recently determined performance attributes retrieved from said performance metric store.

17. The system as claimed in claim 7, wherein said performance monitoring service is a trusted third party.

18. A computer program product in a computer readable medium for monitoring performance of Web service providers in a Universal Description, Discovery and Integration system, said computer program product comprising:
instructions for requesting data from a Web service provider;
instructions for determining at least one performance attribute for said Web service provider based upon data returned from said Web service provider; and,
instructions for storing said at least one performance attribute in a performance metric store.

19. The computer program product as claimed in claim 18, including instructions for periodically initiating said instructions for requesting data from said Web service provider.

20. The computer program product as claimed in claim 19, including instructions for storing in said performance metric store a most recently determined performance attribute for said Web service provider.
